(19) United States
(12) Patent Application Publication
(10) Pub. No.: US 2013/0136131 A1
(43) Pub. Date: May 30, 2013

(54) RELAY DEVICE AND ACTIVATION METHOD OF ELECTRONIC DEVICE

(71) Applicant: BUFFALO INC., Nagoya-shi (JP)

(72) Inventor: Kenji HIRAI, Nagoya-shi (JP)

(73) Assignee: BUFFALO INC., Nagoya-shi (JP)

(21) Appl. No.: 13/687,196

(22) Filed: Nov. 28, 2012

(30) Foreign Application Priority Data
Nov. 30, 2011 (JP) 2011-262494

(51) Int. Cl. H04L 12/56

(52) U.S. Cl. CPC H04L 45/74
USPC 370/392

(57) ABSTRACT

A relay device for relaying a communication packet between a first network and a second network. The relay device stores a first correlation information correlating an Internet Protocol (IP) address assigned to an electronic device in the first network to a Media Access Control (MAC) address of the electronic device. The relay device then determines a MAC address of a forwarding destination of a specific communication packet for enabling a service provided by the electronic device after activation of the electronic device by referring to at least the first correlation information using destination information in the specific communication packet, when the specific communication packet sent from the second network toward the first network is received by the relay device; and transmits an activation request packet to the electronic device using the determined MAC address.

### CROSS-REFERENCE TO RELATED APPLICATIONS

This application claims priority to Japanese Patent Application No. 2011-262494 filed on Nov. 30, 2011, which is hereby incorporated by reference in its entirety and for all purposes.

### BACKGROUND

1. Field of the Disclosure

The present disclosure relates to technology of activating an electronic device.

2. Description of Related Art

The activation technology of powering on an electronic device via a network has been known. This activation technology sends an activation request packet to the electronic device to activate the electronic device. One known example of such activation technology is WOL (Wake-On-LAN) that uses an activation request packet called magic packet to power on the electronic device.

The method proposed in JP 2009-199283A uses this known activation technology and operates a cell phone from outside of home to activate a home server connected to a local network at home. When a router in a home network receives an activation request packet from the cell phone via the Internet, this proposed method employs the port forwarding technique to forward the received activation request packet to the home server, so as to activate the home server.

This method requires the user to operate UI (User Interface) for transmission of the activation request packet on the screen of the cell phone, in order to activate the home server. For example, the user is required to operate the cell phone and activate a program for transmission of the activation request packet. The user is also required to use GUI (Graphical User Interface) displayed on the screen of the cell phone to input various pieces of information, for example, a MAC address of the home server as the activation object and a destination port number used for transmission of the activation request packet. The user is further required to perform an operation of providing a transmission instruction of the activation request packet. After this operation, the user uses an application installed in the cell phone to re-access the home server after activation. Such operations for activation of the home server are troublesome for the user. It is accordingly required to reduce the user's work load. This problem is not limited to the application of remotely activating the home server at home from the cell phone outside of home but is commonly found in a general application of remotely activating an electronic device connected to a first network from a terminal in a second network having a different network segment from that of the first network.

### SUMMARY

According to one aspect of the disclosure, there is provided a relay device for relaying a communication packet between a first network and a second network. The relay device stores a first correlation information correlating an Internet Protocol (IP) address assigned to an electronic device in the first network to a Media Access Control (MAC) address of the electronic device. The relay device then determines a MAC address of a forwarding destination of a specific communication packet for enabling a service provided by the electronic device after activation of the electronic device by referring to at least the first correlation information using destination information in the specific communication packet, when the specific communication packet sent from the second network toward the first network is received by the relay device; and transmits an activation request packet to the electronic device using the determined MAC address.

The disclosure may be implemented by various aspects other than the relay device described above, for example, an activation method of an electronic device, a program for the relay device, a non-transitory computer-readable storage medium in which the program is stored, and a communication system including the relay device and at least one of an electronic device connected to a first network and a terminal connectable to a second network.

### BRIEF DESCRIPTION OF DRAWINGS

FIG. 1 illustrates the general configuration of a network system constructed by using a relay device according to one embodiment of the disclosure;

FIG. 2 illustrates the general configuration of the relay device;

FIG. 3 illustrates a concrete example of a second table;

FIG. 4 is a flowchart showing a flow of a relay process performed by the relay device; and

FIG. 5 is a flowchart showing a flow of an activation process in the relay process.

### DESCRIPTION OF THE PREFERRED EMBODIMENTS

### A. Embodiment

### A-1. General Configuration of Network System 20

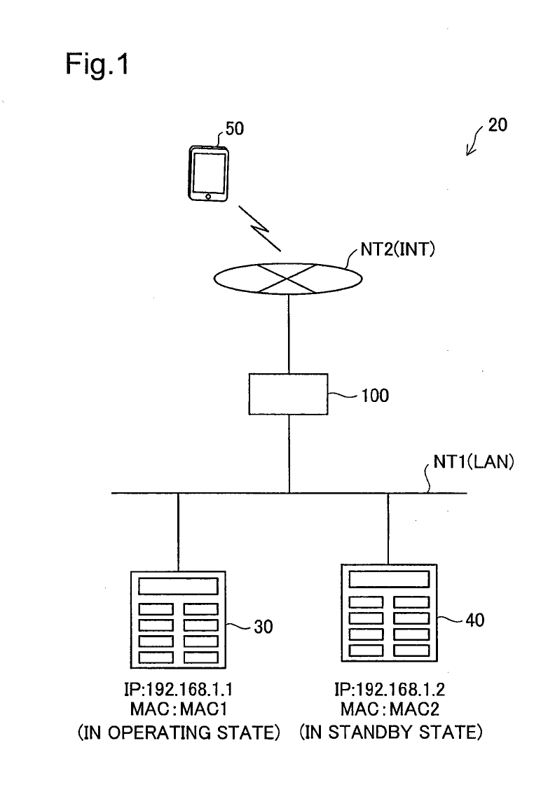

FIG. 1 illustrates the general configuration of a network system 20 including a relay device 100 according to one embodiment of the disclosure. This network system 20 includes a plurality of electronic devices 30 and 40, a relay device 100 and a terminal 50. Although the actual network system further includes connections of various terminals, electronic devices and servers, these connections are omitted from FIG. 1 for convenience of illustration.

According to this embodiment, the electronic device 30 is an NAS (Network Attached Storage). The NAS is a storage device that is communicable via a network. According to this embodiment, the electronic device 40 has WEB server functions. More specifically, when receiving an HTTP request from a WEB browser, the electronic device 40 sends back data stored in a storage area provided in the electronic device 40, as an HTTP response. The electronic devices 30 and 40 support WOL (Wake-On-LAN) and, when receiving an activation request in a standby state (standby mode), are activated to an operating state (operating mode).

The electronic devices 30 and 40 are connected to a first network NT1. According to this embodiment, the first network NT1 is a local area network. The electronic device 30 has “192.168.1.1” as a private IP address assigned in the first network NT1. Similarly the electronic device 40 has “192.168.1.2” as a private IP address assigned. According to this embodiment, these private IP addresses are assigned in a fixed manner by the user's operations. In other words, these private IP addresses are not dynamically assigned by DHCP (Dynamic Host Configuration Protocol). In the description below, the MAC address of the electronic device 30 is called “MAC1”. Similarly the MAC address of the electronic device 40 is called “MAC2”.

The relay device 100 is connected to both the first network NT1 and a second network NT2 and has a first IP address (private IP address) for the first network NT1 and a second IP address (global IP address) for the second network NT2. The relay device 100 serves to relay communication packets between the first network NT1 and the second network NT2. According to this embodiment, the relay device 100 is a router. The second network NT2 has a different segment from that of the first network NT1. More specifically, the first network NT1 and the second network NT2 have different network addresses (network segments) out of the network segment and the host segment of the IP address. According to this embodiment, the second network NT2 is the Internet, and the relay device 100 is connected to the second network NT2 via a modem (not shown).

The terminal 50 is a communication terminal connectable to the second network NT2. According to this embodiment, the terminal 50 is a cell phone. The terminal 50 is connectable to the second network NT2 by wireless communication using a mobile communication network via a base station (not shown in FIG. 1).

In this network system 20, the user is allowed to activate the electronic devices 30 and 40 connected to the first network NT1 via the second network NT2 and the relay device 100 through the user's operations of the terminal 50. The following describes a process of activating the second electronic device 40 on the assumption that the first electronic device 30 is in the operating state and the second electronic device 40 is in the standby state.

### A-2. General Configuration of Relay Device 100

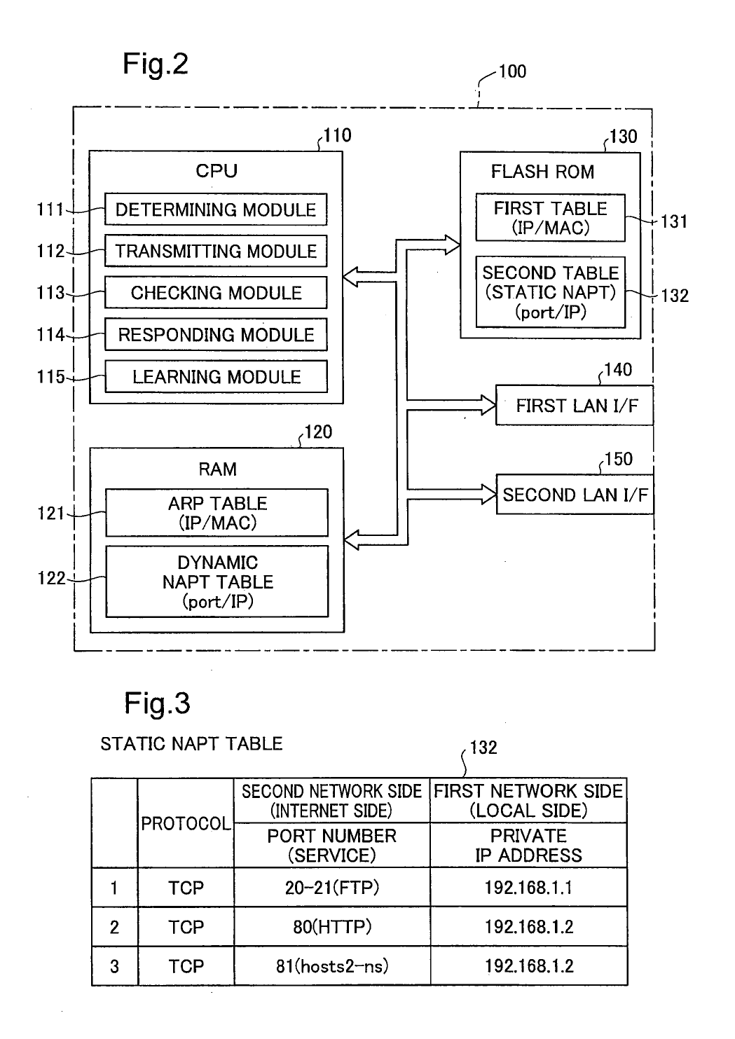

FIG. 2 illustrates the general configuration of the relay device 100. The relay device 100 includes a CPU 110, a RAM 120, a flash ROM 130, a first LAN interface (I/F) 140 and a second LAN interface 150, wherein these circuits are interconnected by a bus.

The CPU 110 executes a program stored in the flash ROM 130 to control the overall operations of the relay device 100. According to this embodiment, the CPU 110 is allowed to forward communication packets using dynamic NAPT (Network Address Port Translation) and static NAPT. Communication packets using NAT (Network Address Translation) are not forwarded in this embodiment. The CPU 110 also executes a program to serve as a processor determining module 111, a processor transmitting module 112, a processor checking module 113, a processor responding module 114 and a processor learning module 115. The details of these functional blocks will be described later.

An ARP (Address Resolution Protocol) table 121 is stored in the RAM 120. The IP addresses (private IP addresses) of the electronic devices 30 and 40 connected to the first network NT1 are registered in the ARP table 121, in correlation to the MAC addresses of the electronic devices 30 and 40. The relay device 100 uses the ARP to obtain a MAC address corresponding to the IP address of each electronic device and registers the obtained MAC address in the ARP table 121. Each correlation between IP address and MAC address registered in the ARP table 121 is deleted from the ARP table 121 by the CPU 110 when a predetermined retention time has elapsed without communication between the electronic device with the IP address and the relay device 100. This control is called timeout deletion.

A dynamic NAPT table 122 for enabling dynamic NAPT is also stored in the RAM 120. As is known in the art, when the relay device 100 receives a communication packet as a reply from a server in the second network NT2 after access of an electronic device in the first network NT1 to the server, the dynamic NAPT table 122 is used to determine the forwarding destination of the communication packet. When a communication packet received from the electronic device in the first network NT1 is forwarded to the server in the second network NT2, a source IP address of the communication packet is registered in the dynamic NAPT table 122, in correlation to a source port number and a new source port number obtained by conversion of the source port number (hereinafter referred to as converted source port number).

The flash ROM 130 is a non-volatile storage medium. A first table 131 and a second table 132 are stored in the flash ROM 130. The non-volatile storage medium provided in the relay device 100 is, however, not limited to the flash ROM but may be any of various other storage media. For example, the storage medium is not a static storage medium like flash ROM but may be a hard disk drive.

The IP addresses (private IP addresses) assigned to the electronic devices 30 and 40 in the first network NT1 are registered in the first table 131, in correlation to the MAC addresses of the electronic devices 30 and 40. According to this embodiment, information is registered in the first table 131, based on the information registered in the ARP table 121. Specifically, the CPU 110 of the relay device 100 refers to the ARP table 121 at regular intervals and registers the information registered in the ARP table 121 into the first table 131. More specifically, the CPU 110 registers a correlation between IP address and MAC address that has not yet been registered in the first table 131 out of the information stored in the ARP table 121, into the first table 131. When another correlation of the same IP address to a different MAC address from the correlation to be currently registered has already been stored in the first table 131, this old correlation is deleted. In this operation, the frequency when the CPU 110 refers to the ARP table 121 is preferably set to a frequency corresponding to a shorter time period than the predetermined retention time for timeout deletion of the ARP table 121. This enables the information registered in the ARP table 121 to be reliably reflected in the first table 131, prior to the timeout deletion.

The timeout deletion applied to the ARP table 121 is not applied to this first table 131. More specifically, a correlation between the IP address and the MAC address registered in the first table 131 is not deleted from the first table 131 even when the predetermined retention time for timeout deletion of the ARP table 121 has elapsed without communication using the correlation. According to this embodiment, only when the CPU 110 receives a deletion command by the user's input, the CPU 110 deletes a specified piece of information from the information registered in the first table 131. Otherwise the CPU 110 continuously retains the information registered in the first table 131. The timing of deleting the information from the registry in the first table 131 is, however, not limited to the timing of this embodiment. For example, a correlation between IP address and MAC address registered in the first table 131 may be deleted when a predetermined second time longer than the predetermined first time for timeout deletion of the ARP table 121 has elapsed without communication using the correlation.

Destination port numbers used for accesses from the terminal 50 to the electronic devices 30 and 40 are registered in the second table 132, in correlation to the IP addresses (private IP addresses) of the electronic devices 30 and 40 in the first network NT1. In other words, the second table 132 is a static NAPT table. The details of the second table 132 will be described later. The dynamic NAPT table 122 and the second table 132 may be integrated as one NAPT table. This modified configuration enables the relay device 100 to use a NAPT table provided in a general-purpose router, thus enhancing the versatility of the relay device 100. In this modification, one NAPT table may be stored in the RAM 120 or may alternatively be stored in the flash ROM 130.

The first LAN interface 140 and the second LAN interface 150 are connected with the CPU 110 via a MAC chip (not shown). The first LAN interface 140 serves as an interface for connection to the first network NT1. The first LAN interface 140 is connected with the electronic devices 30 and 40 via the first network NT1. The second LAN interface 150 serves as an interface for connection to the second network NT2. The second LAN interface 150 is connected to the second network NT2 via a modem. The modem may be built in the relay device 100. According to this embodiment, the first LAN interface 140 and the second LAN interface 150 conform to the IEEE802.3 standard.

FIG. 3 illustrates a concrete example of the second table 132 (dynamic NAPT table). The second table 132 correlates the combinations of the IP address of the relay device 100 having the second table 132 and specified port numbers to the private IP addresses of the electronic devices 30 and 40 connected to the first network NT1. The private IP address is assigned to a packet in the first network NT1, so that the description of “first network side (local side)” is posted over the “private IP address” column. The port number and the IP address of the relay device 100 are assigned to a packet in the second network NT2, so that the description of “second network side (Internet side)” is posted over the “port number” column. The IP address of the relay device 100 is a fixed value and is thus omitted from the illustration of FIG. 3. A correlation of port numbers “20-21” to the private IP address “192.168.1.1” on the local side is registered in the second table 132. Similarly a correlation of a port number “80” to the private IP address “192.168.1.2” and a correlation of a port number “81” to the private IP address “192.168.1.2” are registered in the second table 132. The port numbers “20-21” represent FTP (File Transfer Protocol). The port number “80” represents HTTP (HyperText Transfer Protocol). The port number “81” represents hosts2-ns. The IP address “192.168.1.1” is the private IP address of the first electronic device 30. The IP address “192.168.1.2” is the private IP address of the second electronic device 40.

According to this embodiment, the correlation information in the second table 132 is registered in advance by the user's manual input. In other words, the relay device 100 receives the user's input of the correlation information and registers the input correlation information into the second table 132. Any of various techniques may be employed for such registration. For example, the user may directly connect a personal computer with the first LAN interface 140 of the relay device 100 to input the correlation information via a WEB browser on the personal computer. In another example, the user may connect a personal computer to the first network NT1 to input the correlation information via a WEB browser on the personal computer. In yet another example, when the relay device 100 is equipped with a display, the user may input the correlation information by GUI (Graphical User Interface) on the display.

The port numbers registered in the second table 132 may be numbers corresponding to the applications or services that may be provided by the electronic devices 30 and 40. These port numbers may also be numbers corresponding to the applications or services used by the terminal 50 connected to the second network NT2 to establish communication with the electronic devices 30 and 40.

The correlation information registered in the second table 132 may be arbitrarily determined by the user. In other words, the correlation information registered in the second table 132 may correlate one or a plurality of port numbers to the IP addresses assigned to one or a plurality of electronic devices connected to the first network NT1. The port numbers are not limited to well known port numbers (numbers in the range of 0 to 1023) but may be, for example, registered port numbers (numbers in the range of 1024 to 49151).

### A-3. Relay Process

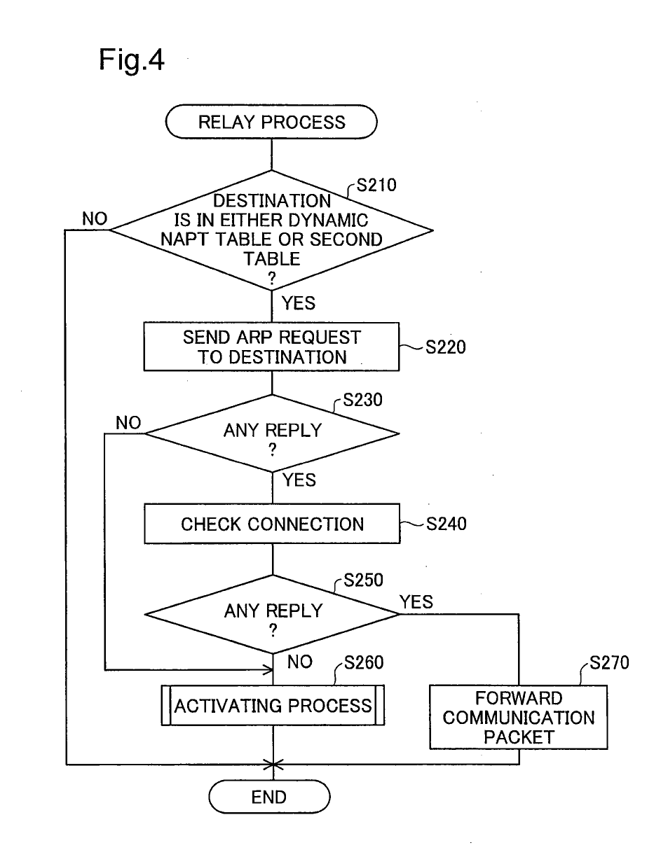

FIG. 4 illustrates a flow of relay process performed by the relay device 100. The relay process forwards a communication packet received from the second network NT2 to either the electronic device 30 or the electronic device 40 in the first network NT1 and includes a process of activating the communication device 40 in the first network NT1 (step S260). The term “activating” or “activation” herein means shifting the state of an electronic device from a state that is incapable of providing essential functions or services that may be provided via a network by the electronic device to a state that is capable of providing the essential functions or services. For example, when the electronic device is a storage device, the essential functions or services may include operations of writing into the storage medium and obtaining information stored in the storage medium. In another example, when the electronic device is a personal computer, the essential functions or services may include arithmetic operations involved in various communications by the CPU. One typical mode of “activation” powers on an electronic device in the OFF state to shift the state of the electronic device to the state that is capable of providing the functions or services of the electronic device. When the electronic device conforms to ACPI (Advanced Configuration and Power Interface), another typical mode of “activation” shifts the state of the electronic device from any of states S1 to S5 to state S0. In WOL (Wake-On-LAN), the state of the electronic device is generally shifted from the state S5 to the state S0. The “activated state” according to this embodiment means the state after the “activation”, i.e., the state of the electronic device that is capable of providing at least part of the essential functions or services of the electronic device via the network. The “activated state” is also called “operating state” or “operating mode”. The state of the electronic device before the “activation” is called “standby state” or “standby mode”. In the standby state, the CPU of the electronic device generally stops, and only part of the circuit operates to enable activation of the electronic device from the standby state to the operating state in response to reception of an activation request.

According to this embodiment, the relay process is repeatedly performed whenever the relay device 100 receives a communication packet from the second network NT2 toward the first network NT1. The relay process starts, for example, when the terminal 50 uses an application installed in the terminal 50 to access the relay device 100 and the relay device 100 receives a communication packet. Examples of such application include WEB browser and FTP client application.

On the start of the relay process, the CPU 110 of the relay device 100 first serves as its processor determining module 111 to determine whether a destination (forwarding destination) of a communication packet received from the terminal 50 via the second LAN interface 150 is registered in either the dynamic NAPT table 122 or the second table 132 (static NAPT table), i.e., determine whether the destination is known (step S210). The process of step S210 identifies the forwarding destination of the received communication packet. When the private IP address of the destination (electronic device 30 or electronic device 40) is obtainable based on the dynamic NAPT table 122 or the second table 132, the CPU 110 determines that the destination is known. Otherwise the CPU 110 determines that the destination is unknown.

The private IP address of the destination is obtained at step S210 by the following procedure. When referring to the dynamic NAPT table 122, the CPU 110 determines whether a converted source port number identical with a destination port number included in the received communication packet is registered in the dynamic NAPT table 122. When registered, the CPU 110 obtains the private IP address and the source port number correlated to the converted source port number from the dynamic NAPT table 122. When referring to the second table 132 (static NAPT table), on the other hand, the CPU 110 determines whether a port number identical with a destination port number included in the received communication packet is registered in the second table 132 (FIG. 3). When registered, the CPU 110 obtains the private IP address correlated to the port number from the second table 132. For example, when the received communication packet includes a destination port number “80”, the CPU 110 refers to the second table 132 to obtain the correlated private IP address “192.168.1.2” of the electronic device 40.

When it is determined that the destination port number is not registered in either of the tables 122 and 132 at step S210, the CPU 110 terminates the relay process. In other words, since the destination of the received communication packet is unknown, the CPU 110 discards the received communication packet. When it is determined that the destination is known at step S210, on the other hand, the CPU 110 serves as its processor checking module 113 to send an ARP request to the electronic device (e.g., electronic device 40) having the private IP address of the known destination (step S220). The CPU 110 then serves as its processor checking module 113 to determine whether an ARP reply is received in response to the sent ARP request (step S230). Not receiving the ARP reply means that the electronic device 40 as the destination of the ARP request is in the state that is incapable of sending back an ARP reply, i.e., in the inactivated state. The determination of step S230 accordingly checks whether the electronic device 40 identified as the forwarding destination of the received communication packet is in the activated state.

Receiving the ARP reply at step S230, on the other hand, indicates a high possibility that the electronic device identified as the forwarding destination is in the activated state. Some electronic devices may be capable of receiving an ARP request and sending back an ARP reply as a response even in the inactivated state. When it is determined that an ARP reply is received at step S230, the CPU 110 serves as its processor checking module 113 to check the connection using a protocol on a network layer or an upper layer in the OSI reference model (step S240). For example, the CPU 110 employs TCP (Transmission Control Protocol) to send an SYN packet and determines whether an ACK packet is received as a response to check the connection.

When the result of such connection check indicates that the ACK packet is received (step S250: YES), this means that the electronic device identified as the forwarding destination is in the activated state. When it is determined that the ACK packet is received, the CPU 110 forwards the communication packet received from the second network NT2 to the electronic device identified as the forwarding destination (step S270) and terminates the relay process. The CPU 110 may receive the MAC address of the electronic device identified as the forwarding destination by receiving the ARP reply. As clearly understood from the above description, the process of steps S220 to S250 checks whether the electronic device identified as the forwarding destination of the received communication packet is in the activated state and is specified as the process performed by the processor checking module 113 shown in FIG. 1.

When it is determined that no ACK packet is received at step S250 or when it is determined that no ARP reply is received at step S230, on the other hand, this means that the electronic device 40 identified as the forwarding destination is in the inactivated state. In such cases, the CPU 110 performs an activation process to activate the electronic device 40 (step S260) and terminates the relay process.

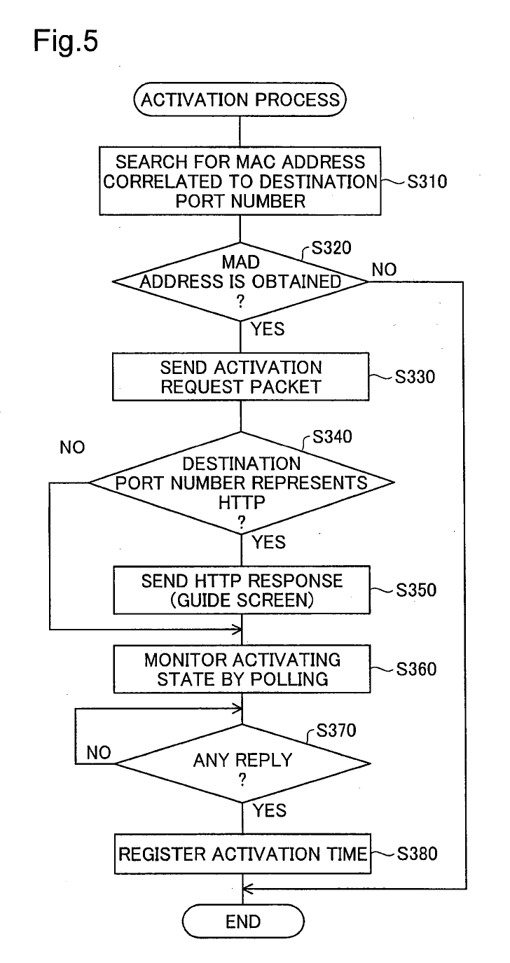

FIG. 5 illustrates a flow of the activation process. On the start of the activation process, the CPU 110 first refers to the first table 131 and the second table 132 to search for a MAC address correlated to the destination port number of the received communication packet (step S310). When the private IP address obtained at step S210 of FIG. 4 is used for the process of step S310, the process of step S310 may not refer to the second table 132.

When no MAC address is obtained (step S320: NO), the CPU 110 terminates the activation process. When any MAC address is obtained (step S320: YES), on the other hand, the CPU 110 serves its processor transmitting module 112 to generate an activation request packet using the obtained MAC address and send the generated activation request packet via the first LAN interface 140 (step S330).

According to this embodiment, the CPU 110 sends a magic packet used in WOL as the activation request packet. In the magic packet, data pattern including sixteen repetitions of the MAC address of the device as the activation object subsequent to a synchronization sequence “FF:FF:FF:FF:FF:FF” is described in any area of the payload field. The CPU 110 broadcasts the magic packet including the MAC address obtained at step S310. When the MAC address included in the received magic packet does not match with its own MAC address, the electronic device 30 or 40 ignores the received magic packet. When the MAC address included in the received magic packet matches with its own MAC address, on the other hand, the electronic device 30 or 40 activates itself. The format of the activation request packet is not limited to this example but may be any format supported by the relay device 100 and the electronic device as the activation object. The electronic device as the activation object may interpret the received activation request packet by software.

After sending the activation request packet, the relay device 100 serves as its processor responding module 114 to determine whether the destination port number included in the communication packet received at step S210 of FIG. 4 is the number representing HTTP (step S340). More specifically, the CPU 110 determines whether the destination port number is equal to “80”. In the description hereof, the term “HTTP” may include HTTPS (HTTP over SSL/TLS). The relay device 100 may thus determine whether the destination port number is either one of “80” and “443” at step S340.

When it is determined that the destination port number is the number representing HTTP at step S340, the CPU 110 serves as its processor responding module 114 to send an HTTP response as the reply to the received HTTP request (step S350). This process may be performed by, for example, transparent proxy. This HTTP response includes data for providing the user of the terminal 50 with display of a guide screen. According to this embodiment, the data for displaying a guide screen includes time information indicating a time required for activation of the electronic device 40 that is activated in response to the operation of step S330, i.e., an estimated time from reception of an activation request packet to completion of activation. The time required for activation is hereinafter called activation time.

The guide screen may include character information, such as “The electronic device is activating. The time to activation is about 4 minutes”. In this case, “about 4 minutes” is the time information. According to this embodiment, the time information included in the guide screen is determined on the basis of the activation time automatically learnt by the process of steps S360 to S380 described below. For example, when the learnt activation time is 4 minutes and 20 seconds, the time information may be determined as “about 4 minutes” or “about 5 minutes”. Alternatively the time information included in the guide screen may be the learnt activation time. In this case, the time information may be “4 minutes and 20 seconds”. According to this embodiment, when the activation time has not yet been learnt in the past with respect to the electronic device 40 as the activation object, the guide screen does not include the time information. In this case, the character information may be, for example, “The electronic device is activating”. The process of steps S340 and S350 may be performed before the process of step S330.

After sending the HTTP response, the CPU 110 serves as its processor learning module 115 to monitor the activating state of the activation object device (e.g., electronic device 40) by polling (step S360). The term “polling” herein means sending a communication packet at regular intervals to the electronic device 40 as the activation object and monitoring its response. In one example of polling, when no ARP reply is received at step S230, the CPU 110 may send the ARP request at regular intervals at step S360 as polling. In another example, when no ACK packet is received at step S250, the CPU 110 may send the SYN packet at regular intervals at step S360 as polling. The timeout setting may be employed for polling. More specifically, when activation of the activation object device is not confirmed within a predetermined time since start of polling, the polling operation may be stopped. This advantageously prevents useless continuation of the polling operation in the event of failure in activation of the activation object device. The default setting for timeout may be, for example, 5 minutes.

On the start of polling, the CPU 110 serves as its processor learning module 115 to wait for receiving a reply packet from the electronic device 40 (step S370). When receiving the reply packet, the CPU 110 serves as its processor learning module 115 to register the time from reception of the activation request packet to reception of the reply packet by polling as the activation time of the electronic device 40 in the flash ROM 130 (step S380). This activation time is registered in correlation to the electronic device 40. For example, the activation time may be registered in correlation to the MAC address of the electronic device 40. By learning the activation time of the electronic device 40 as described above, the CPU 110 can determine the time information based on the learnt activation time at step S350 in a next cycle of the activation process.

On completion of the activation process, the CPU 110 returns the processing flow to the relay process. In the relay process described above, part or all of steps S220 to S250 and steps S340 to S380 may be omitted as appropriate. In the modified process flow without steps S240 and S250, when an ARP reply is received (step S230: YES), the processing of the CPU 110 may proceed to step S270. When an ARP reply is received (step S230: YES) but no ACK packet is received (step S250: NO), the process of steps S310 and S320 may be omitted. In this case, the CPU 110 may send an activation request packet at step S330 using the MAC address obtained by the ARP reply. In other words, the CPU 110 may obtain the MAC address by referring to the first table 131 or by the ARP reply.

### A-4. Advantageous Effects of Embodiment

When receiving a communication packet from the second network NT2 toward the first network NT1, the relay device 100 described above refers to the tables 131 and 132 to obtain the MAC address of the forwarding destination of the received communication packet and sends an activation request packet to the electronic device identified as the forwarding destination using the MAC address, so as to activate the electronic device as the forwarding destination. The communication packet received from the second network NT2 is not required to be an activation request packet but may be a communication packet for enabling the application or service executable by the electronic device after activation. For example, the electronic device 40 may be activated by the user's operation of executing an application on the terminal 50 to request for the service of a port number registered in the second table 132 (FIG. 3) and gain access from the terminal 50 to the relay device 100 via the second network NT2. The terminal 50 does not establish communication with the electronic device 40 until completion of activation of the electronic device 40. In this case, access from the terminal 50 is retried in a predetermined time period. When the time required for activation of the electronic device 40 is shorter than the time period for retry, the user can establish communication between the terminal 50 and the electronic device 40 without any additional operation by simply waiting for the activation time. When the time required for activation of the electronic device 40 is longer than the time period for retry, on the other hand, the user can establish communication between the terminal 50 and the electronic device 40 by performing the access operation again after completion of activation of the electronic device 40. In either case, the user can activate the electronic device 40 and use the application by the simple operation related to the application installed in the terminal 50. In other words, the user is not required to operate the GUI for the application provided for only transmission of the activation request packet, such as WOL, on the terminal 50. This advantageously reduces the user's work load.

When receiving a communication packet from the second network NT2, the relay device 100 checks whether the electronic device as the forwarding destination of the received communication packet is in the activated state and sends an activation request packet only when the electronic device as the forwarding destination is in the inactivated state. This advantageously reduces the load of the first network NT1. In case where the activation request packet is transmitted by broadcasting, the processing loads of the electronic devices 30 and 40 connected to the first network NT1 are further reduced.

The correlations of the IP address to the port number and to the MAC address are separately managed in the first table 131 and in the second table 132 in the flash ROM 130 of the relay device 100. This facilitates the user's management of the first table 131 and the second table 132. For example, when the correlation information registered in the first table 131 needs to be update, only the correlation information in the first table 131 may be displayed for the user's input. This prevents the correlation information in the second table 132 from being displayed unnecessarily, thus enhancing the user's convenience. Additionally, the CPU 110 of the relay device 100 refers to only the table required for processing out of the first table 131 and the second table 132 during the activation process. This advantageously reduces the amount of information to be referred to by the CPU 110, thus promoting the efficiency of the processing and accelerating the processing.

The relay device 100 uses the ARP to obtain the MAC addresses of the electronic devices 30 and 40, registers the obtained MAC addresses into the ARP table 121 and additionally registers the contents of the ARP table 121 in the first table 131. Even when the electronic device 30 or 40 is replaced with another electronic device because of a failure or renewal to a new product, the user is thus not required to register the MAC address of the replaced electronic device in the first table 131 by the manual input. The relay device 100 may, however, be configured to receive the user's manual input of the MAC address and register the input MAC address in the first table 131. The relay device 100 stores the first table 131 separately from the ARP table 121 that is subjected to the timeout deletion. The information stored in the first table 131 is thus not deleted by the timeout deletion applied to the ARP table 121. As a result, even when the electronic state 40 is in the inactivated state, the relay device 100 can obtain the MAC address of the electronic device 40 and send an activation request packet to the electronic device 40.

The relay device 100 sends an activation request packet to the electronic device 40 according to the type of the communication packet received from the terminal 50. When the communication packet received from the terminal 50 is an HTTP request, the relay device 100 sends an HTTP response for displaying a guide screen to the terminal 50. This enables the user to check the HTTP response screen on the display of the terminal 50 and to be readily notified of the state of the electronic device 40 as the activation object and the user's required operation, thus enhancing the user's convenience. When the HTTP response screen includes the time information representing the activation time, the user is notified of the time required for activation of the electronic device 40. Additionally, when a reaccess is required for the electronic device 40 after the activation, the user is notified of the timing of reaccess. This further enhances the user's convenience.

The relay device 100 can learn the time information representing the individual activation times of the plurality of electronic devices 30 and 40 and notify the user of the time information with high accuracy. This enhances the user's convenience. The relay device 100 can notify the user of the time information with high accuracy, for example, when the activation time of the electronic device 30 or 40 changes over a long time period or update of the firmware in the electronic device 30 or 40 or additional incorporation of a new hardware component changes the activation time of the electronic device 30 or 40.

### B. Modifications

### B-1. Modification 1

The relay process (FIG. 4) described above checks whether the electronic device in the first network NT1 is in the activated state (hereinafter also referred to as “activation check”) by transmission of an ARP response and an SYN packet as the relay at steps S220 and S230. Neither the configuration for activation check nor the details of the processing is, however, specifically limited to the above embodiment. The activation check may be performed by any configuration that sends a communication packet and checks the presence or the absence of its reply. For example, the relay device 100 may use ping for the activation check.

### B-2. Modification 2

The data of the HTTP response for displaying the guide screen sent at step S350 includes the time information representing the activation time of the electronic device in the activation process (FIG. 5) described above, but the contents of the guide screen may be set arbitrarily. For example, the guide screen may include information regarding activation of the electronic device as the activation object. The information regarding the activation may be information indicating that the electronic device is in the activated state or may be time information based on the activation time. In another example, the guide screen may include information regarding the user's operation. The information regarding the user's operation may be character information that urges the user's reaccess or more specifically character information such as “Please access again”. In yet another example, the guide screen may include information regarding the user's standby. The information regarding the user's standby may be character information that urges the user's standby. The time information based on the activation time may be regarded as the information regarding the user's standby. These pieces of information may be used in combination as appropriate.

The relay device 100 may send image data to ask for the user's approval or disapproval for activation of the activation object device as the HTTP response, before sending an activation request packet to the activation object device. The activation request packet may be sent to the activation object device only when the user inputs approval for activation of the activation object device on the display screen of the HTTP response received by the terminal 50 and the relay device 100 receives the user's input. This configuration prevents the activation object device from being activated against the user's intention.

When a communication packet using a different protocol is received as a request, in place of or in addition to the HTTP request, the relay device 100 may send a guide screen or image data as its reply. The different protocol may be any of various protocols that are capable of responding screen data for providing a display in response to the request. Concrete examples of the different protocol include FTP, Telnet (Telecommunication network) and SSH (Secure Shell).

### B-3. Modification 3

When the user registers a correlation between port number and private IP address in the second table 132 (FIG. 3), the relay device 100 may receive the user's input with respect to the type of the device having the private IP address. The CPU 110 serving as its processor responding module 114 may specify the time information according to the device type. In this case, the device type may be input into the second table 132 by selecting an appropriate device type in a list of device types. The relay device 100 may store in advance a correlation of the device type to the time information in a non-volatile storage area and specify the time information based on the stored correlation. The stored time information may be the general activation time or the average activation type according to the device type. This configuration enables the relay device 100 to provide the user with the time information stored in advance, even when the relay device 100 is incapable of learning the time information. This configuration also enables the relay device 100 to provide the user with the time information before the time information is learnt. The device type may be classified, based on the main functions of each device. Alternatively two devices having identical main functions but different model numbers or different firmware versions may be specified as different device types.

### B-4. Modification 4

The user of the relay device 100 may perform an operation test of the relay device 100 at the time of initial use of the relay device 100. The operation test may be performed as a connection check test. In the connection check test, in the state that the electronic devices 30 and 40 connected to the first network NT1 are activated, the relay device 100 may send an ARP request to each of the electronic devices 30 and 40 and check its reply. This enables required information to be registered in the first table 131 at the time of initial use of the relay device 100. In this case, the relay device 100 may automatically and sequentially perform the connection check test in response to the user's start instruction for the connection check test. This advantageous reduces the user's work load.

The operation test of the relay device 100 may include an activation check test of the electronic device. In the activation check test, in the state that the electronic devices 30 and 40 in the first network NT1 are in the standby state, the relay device 100 may send an activation request packet to each of the electronic devices 30 and 40 and check whether the electronic device 30 or 40 is activated adequately. This enables the relay device 100 to learn the time information at the time of initial use of the relay device 100. In this case, the relay device 100 may automatically and sequentially perform the activation check test in response to the user's start instruction for the activation check test. This advantageously reduces the user's work load. When the activation test is performed after completion of the connection check test by the ARP, the relay device 100 has already obtained the MAC addresses of the electronic devices 30 and 40 and can thus automatically send a magic packet.

The activation test may not be performed individually for the electronic devices 30 and 40 in the first network NT1. For example, as described above in Modification 3, when receiving the input of the device type corresponding to each private IP address, the relay device 100 may perform the activation test for each device type. In other words, the activation test may be performed for each device type with respect to only one arbitrary electronic device belonging to the device type. In this case, the CPU 110 may serve as its processor learning module 115 to uniformly apply the learnt time information to all the electronic devices belonging to one identical device type. This configuration enables the time information to be learnt with high efficiency.

### B-5. Modification 5

When the relay device 100 supports UPnP (Universal Plug and Play), UPnP may be used to register the correlation information in the second table 132 (FIG. 3). As is known in the art, UPnP provides the function of automatic port mapping. According to another embodiment, a personal computer with a UPnP application installed therein may be connected with the relay device 100 via the first network NT1 and perform port mapping with respect to a specified destination port number.

### B-6. Modification 6

Although the first table 131 and the second table 132 are stored in the flash ROM 130 as the non-volatile storage medium according to the above embodiment, at least one of these tables may be stored in the RAM 120 as the volatile storage medium. According to another embodiment, the first table 131 and the second table 132 may be structured as one integral table. In this modification, the port numbers, the private IP addresses of the electronic devices 30 and 40 and the MAC addresses of the electronic devices 30 and 40 may be stored in correlation to one another in one integral table. According to yet another embodiment, the first table 131, the second table 132 (static NAPT table) and the dynamic NAPT table 122 may be structured as one integral table.

It is not necessary to provide the first table 131 separately from the ARP table 121. This means that the CPU 110 may use the ARP table 121, in place of the first table 131, during the activation process. This ensures the efficient use of the limited storage area provided in the relay device 100. In this modification, the relay device 100 may be configured to have different retention times set for timeout deletion with respect to the individual correlations between IP address and MAC address registered in the ARP table 121. For example, the longer retention time may be set for the correlations registered in the second table 132 than the retention time set for the other correlations, out of the correlations between IP address and MAC address registered in the ARP table 121. In other example, the timeout deletion may not be applied only to the correlations registered in the second table 132, out of the correlations registered in the ARP table 121. This may be set by the user's manual input or may be set automatically the CPU 110. In yet another example, the timeout deletion may not be applied to the ARP table 121. Any of the configurations of these modifications reduces the possibility that the MAC address used for generation of the activation request packet is unobtainable.

### B-7. Modification 7

In the relay process (FIG. 4) described above, when the relay device 100 receives an activation request packet from the second network NT2, the processing of the CPU 110 proceeds to step S220 and subsequent step as the result of decision at step S210. This means that the CPU 110 performs the activation check (steps S220 and S230 in FIG. 4). The procedure of one modification may, however, skip the activation check when the relay device 100 receives an activation request packet from the second network NT2. In other words, when a communication packet is received from the second network NT2 toward the first network NT1, the CPU 110 may perform the activation check upon satisfaction of two conditions that (i) the forwarding destination of the received communication packet is unidentifiable: and (ii) the received communication packet is not an activation request packet. Registration of the destination port number used for the activation request packet in the relay device 100 enables the relay device 100 to discriminate the activation request packet from other communication packets. It is preferable to assign different numbers to the plurality of relay devices 30 and 40 as the destination port number for the activation request packet sent from the terminal 50 to the relay device 100. This enables the plurality of electronic devices to be activated individually.

In this modification, the CPU 110 may refer to the second table 132 (static NAPT table) and the first table 131 to convert the destination port number of the received activation request packet to a MAC address and forward the activation request packet to the activation object device using the obtained MAC address. In another modification, the relay process may proceed to the process of step S260. Since the user sends the activation request packet, there is high possibility that the electronic device expected to be the destination of the activation request packet is in the inactivated state. The configuration of this modification can omit the activation check (steps S220 to S250) of the electronic device, thus promoting the efficiency of the processing.

### B-8. Modification 8

According to the above embodiment, the IP addresses of the electronic devices 30 and 40 are assigned in a fixed manner by the user's manual input. The IP addresses of the electronic devices 30 and 40 may, however, be assigned by DHCP. In this modification, the DHCP may statistically assign IP addresses of the electronic devices 30 and 40. This modified configuration also adequately maintains the correlations in the first table 131 and in the second table 132.

The IP addresses of the electronic devices 30 and 40 are not necessarily assigned in a fixed manner. For example, when the relay device 100 has the DHCP function to enable dynamic assignment of IP addresses, the CPU 110 may update the first table 131 and the second table 132, based on the IP addresses before and after the change, during assignment of the IP addresses. This modified configuration can adequately maintain the correlations in the first table 131 and in the second table 132, even when the IP addresses of the electronic devices 30 and 40 are changed. In another example, the frequency when the CPU 110 refers to the ARP table 121 and updates the first table 131 may be set to a frequency corresponding to a shorter time period than the predetermined retention time for timeout deletion of the ART table 121. This modified configuration enables the change of the IP address to be reflected on the first table 131 substantially in real time. In yet another example, the CPU 110 may hook a system call issued and refer to the ART table 121 to update the first table 131 whenever the relay device 100 receives an ARP reply. This modified configuration enables the change of the IP address to be reflected on the second table 131 in real time even when the IP address is assigned dynamically.

### B-9. Modification 9

The relay device 100 may specify only part of the port numbers registered in the second table 132 (FIG. 3) as the search object at step S310 in FIG. 5. In other words, the relay device 100 may separately manage the port numbers used for only the general static NAPT and the port numbers used for both the activation process and the general static NAPT.

### B-10. Modification 10

The relay device 100 may be configured to perform a process of forwarding a communication packet using NAT, in place of the dynamic NAPT. In this modification, the relay device 100 may refer to an NAT table, instead of the dynamic NAPT table 122 and the second table 132 (static NAPT table), to obtain the private IP address of the forwarding destination at step S210 (FIG. 4). The IP address (generally global IP address) of the relay device 100 in the second network NT2 is stored in correlation to the private IP address of one electronic device (e.g., electronic device 30) in the first network NT1 in the NAT table. When receiving a communication packet from the second network NT2, the relay device 100 may determine the private IP address of the forwarding destination, based on the destination IP address included in the received communication packet (i.e., the IP address of the relay device 100 in the second network NT2) and the NAT table. The relay device 100 then uses the first table 131 to determine the MAC address of the forwarding destination. The destination IP address included in the communication packet is used for determination of the MAC address of the forwarding destination, but the destination port number is not used for such determination. As clearly understood from the description of this modification and the above embodiment, the MAC address of the forwarding destination may be determined by referring to at least the first table 131, in combination with the destination information (destination port number, destination IP address or both) included in the received communication packet.

### B-11. Modification 11

Although WOL is used as the protocol for activating the electronic devices 30 and 40 according to the above embodiment, the protocol used for activation is not specifically limited. The protocol may be any protocol supported by the electronic devices 30 and 40. The activation request packet may have a format suitable for the protocol.

### B-12. Modification 12

The electronic device as the activation object is not limited to the NAS but may be any of various electronic devices that are communicable via a network. For example, the electronic device may be a personal computer or any of various network-compatible home electrical appliances.

### B-13. Modification 13

The first network NT1 and the second network NT2 are not limited to the above embodiment but may be any networks having different segments. For example, both the first network NT1 and the second network NT2 may be local area networks.

The foregoing describes the embodiment of the disclosure and its modifications. The disclosure is, however, not limited to the above embodiment or modifications but various other modifications and variations may be made to the embodiment and its modifications without departing from the scope of the disclosure. For example, the components in any of the embodiments and modifications described above may be adequately combined, omitted or conceptualized to the broader sense in the aspect of solving at least part of the problem described above or in the aspect of achieving at least part of the advantageous effects described above.

What is claimed is:

1. A relay device for relaying a communication packet between a first network and a second network, the relay device comprising:
a storage storing first correlation information correlating an Internet Protocol (IP) address in the first network assigned to an electronic device in the first network to a Media Access Control (MAC) address of the electronic device; and
a processing unit configured to:
determine a MAC address of a forwarding destination of a specific communication packet for enabling a service provided by the electronic device after activation of the electronic device by referring to at least the first correlation information using destination information in the specific communication packet, when the specific communication packet sent from the second network toward the first network is received by the relay device; and
control transmission of an activation request packet to the electronic device using the determined MAC address.

2. The relay device according to claim 1, wherein
the processing unit is further configured to:
check whether the electronic device is in an activated state when the relay device receives the specific communication packet; and
control transmitting the activation request packet only when it is determined that the electronic device is not in the activated state.

3. The relay device according to claim 1, wherein
the first correlation information is stored separately from an Address Resolution Protocol (ARP) table stored by the relay device.

4. The relay device according to claim 3, wherein
a timeout deletion applied to the ARP table is not applied to the first correlation information.

5. The relay device according to claim 2, wherein
the specific communication packet includes a request packet for requesting a service in conformity to a protocol that is capable of sending back screen data as a reply to the request packet, and
the processing unit is further configured to send a reply packet including screen data for displaying a guide screen relating to at least one of activation of the electronic device, a user's operation and the user's standby as the reply to the request packet.

6. The relay device according to claim 5, wherein
the screen data for displaying the guide screen includes time information representing an estimated value of a time required for activation of the electronic device.

7. The relay device according to claim 6, wherein
the processing unit is further configured to acquire an activation time required from transmission of the activation request packet to the electronic device to completion of activation of the electronic device, and determine the estimated value of the time required for activation of the electronic device based on the acquired activation time.

8. The relay device according to claim 1, wherein
the storage further stores second correlation information correlating a port number included in the destination information to the IP address in the first network assigned to the electronic device.

9. The relay device according to claim 8, wherein
the processing unit is further configured to determine the MAC address of the forwarding destination of the specific communication packet by referring to the second correlation information and the first correlation information using a destination port number included in the specific communication packet.

10. The relay device according to claim 1, wherein
the storage further stores third correlation information correlating an IP address of the relay device in the second network to a IP address of the electronic device in the first network.

11. The relay device according to claim 10, wherein
the processing unit is further configured to determine the MAC address of the forwarding destination of the specific communication packet by referring to the third correlation information and the first correlation information using a destination IP address included in the destination information.

12. An activation method of an electronic device in a first network from a terminal in a second network in an environment where the first network is connected with the second network via a relay device, the activation method comprising:
storing, in the relay device, first correlation information correlating an Internet Protocol (IP) address in the first network assigned to the electronic device in the first network to a Media Access Control (MAC) address of the electronic device;
determining, by the relay device, a MAC address of a forwarding destination of a specific communication packet for enabling a service provided by the electronic device after activation of the electronic device by referring to at least the first correlation information using destination information included in the specific communication packet, when the specific communication packet sent from the second network toward the first network is received by the relay device; and
transmitting, by the relay device, an activation request packet to the electronic device using the determined MAC address.

13. The activation method according to claim 12, wherein
the transmitting includes checking whether the electronic device is in an activated state when the relay device receives the specific communication packet, and sending the activation request packet only when it is determined that the electronic device is not in the activated state.

14. The activation method according to claim 12, wherein
the first correlation information is stored separately from an Address Resolution Protocol (ARP) table stored in the relay device, and
a timeout deletion applied to the ARP table is not applied to the first correlation information.

15. The activation method according to claim 13, wherein
the specific communication packet includes a request packet for requesting a service in conformity to a protocol that is capable of sending back screen data as a reply to the request packet, wherein
the method further comprises:
sending, by the relay device, a reply packet that includes screen data for displaying a guide screen relating to at least one of activation of the electronic device, a user's operation and the user's standby as the reply to the request packet.

16. The activation method according to claim 15, wherein
the screen data for displaying the guide screen includes time information representing an estimated value of a time required for activation of the electronic device.

17. The activation method according to claim 16, further comprising:
acquiring an activation time required from transmission of the activation request packet to the electronic device to completion of activation of the electronic device; and
determining the estimated value of a time required for activation of the electronic device based on the acquired activation time.

18. The activation method according to claim 12, further comprising:
storing second correlation information correlating a port number included in the destination information to the IP address of the electronic device, wherein
the determining includes determining the MAC address of the forwarding destination of the specific communication packet by referring to the second correlation information and the first correlation information using a destination port number included in the specific communication packet.

19. The activation method according to claim 12, further comprising:
storing third correlation information correlating an IP address of the relay device in the second network to the IP address of the electronic device in the first network, wherein
the determining includes determining the MAC address of the forwarding destination of the specific communication packet by referring to the third correlation information and the first correlation information using a destination IP address included in the destination information.

20. A non-transitory computer-readable medium including computer program instructions, which when executed by a relay device operating in an environment including an electronic device in a first network and a terminal in a second network, cause the relay device to perform a process comprising:
storing first correlation information correlating an Internet Protocol (IP) address of the electronic device in the first network to a Media Access Control (MAC) address of the electronic device;
determining a MAC address of a forwarding destination of a specific communication packet for enabling a service provided by the electronic device after activation of the electronic device by referring to at least the first correlation information using destination information included in the specific communication packet, when the specific communication packet sent from the second network toward the first network is received by the relay device; and
transmitting an activation request packet to the electronic device using the determined MAC address.
